(19) United States
(12) Patent Application Publication
(10) Pub. No.: US 2024/0428122 A1
(43) Pub. Date: Dec. 26, 2024

(54) UPDATING MACHINE LEARNING MODELS BASED ON IMPACTS OF FEATURES ON PREDICTIONS

(71) Applicant: Capital One Services, LLC, McLean, VA (US)

(72) Inventors: Samuel SHARPE, Cambridge, MA (US); Christopher Bayan BRUSS, Washington, DC (US); Brian BARR, Schenectady, NY (US)

(73) Assignee: Capital One Services, LLC, McLean, VA (US)

(21) Appl. No.: 18/338,284

(22) Filed: Jun. 20, 2023

(51) Int. Cl. G06N 20/00

(52) U.S. Cl. CPC G06N 20/00

(57) ABSTRACT

Methods and systems are described herein for updating machine learning models based on the impact of features on predictions. The system inputs, into a machine learning model, a dataset including entries and features to obtain predictions. The machine learning model is trained to generate predictions for entries based on features. The system generates, for each entry, feature impact parameters indicating a relative impact of each feature on each prediction. The system determines a feature impact threshold for assessing which features have contributed to each prediction and generates, using the feature impact parameters and the feature impact threshold, a sparsity metric for each prediction. The sparsity metric indicates which features have relative impacts that meet the feature impact threshold for the prediction. The system generates a global sparsity metric for the machine learning model and updates the machine learning model based on the global sparsity metric.

### BACKGROUND

Machine learning models typically rely on a large number of features to generate predictions, even though only a subset of those features may contribute significantly to predictions. For example, specific populations within the model inputs may rely on certain features while other populations within the model inputs may rely on certain other features. Overly complex machine learning models waste resources and are less efficient as compared to simpler machine learning models, for example, that are tailored for specific populations. Furthermore, predictions generated by simpler models are easier to understand and communicate. Initial attempts to handle overly complex models included techniques such as Akaike information criterion (AIC) and Bayesian information criterion (BIC). These techniques enable assessments of model complexity to compare various models to each other. However, these initial attempts do not always facilitate simplifying machine learning models to rely only on those specific features needed for specific populations. Thus, a mechanism is desired for generating and updating machine learning models based on features contributing to predictions.

### SUMMARY

Methods and systems are described herein for generating and/or updating machine learning models based on the impact of features on predictions. A model updating system may be built and configured to perform operations discussed herein. The model updating system may input a dataset into a machine learning model trained to generate predictions for entries based on features. The dataset may include entries with each entry including a number of features. For example, the dataset may include program applicants, and each applicant may be associated with a number of features, such as application materials, scores, applicant attributes, references, or other features. The model updating system may generate feature impact parameters (e.g., local explanations, attributions, or other parameters) indicating a relative impact of each feature on each prediction. For example, the feature impact parameters may indicate the impact of an applicant's scores on a prediction of whether they will be admitted to the program, as well as the impact of the applicant's application materials on the prediction, and so on. The model updating system may then determine a feature impact threshold for assessing which features have contributed to each prediction. For example, the feature impact threshold may be a level below which a feature is not considered to have impacted the prediction for a particular applicant.

The model updating system may then determine which features significantly impacted the prediction. For example, the model updating system may generate a sparsity metric for each prediction using the feature impact parameters and the feature impact threshold. For example, the model updating system may compare each feature impact parameter with the feature impact threshold. The sparsity metric may indicate which features contributed significantly to the prediction. For example, the sparsity metric may indicate that a particular applicant's scores and application materials contributed significantly to a prediction of whether that applicant would be admitted to the program. The model updating system may generate a global sparsity metric for the machine learning model. The global sparsity metric may indicate trends of the feature impact parameters across the dataset. For example, the global sparsity metric may indicate that for a first portion of the applicants, scores and references contributed significantly to their predictions, while for a second portion of the applicants, scores and attributes contributed significantly to their predictions. In yet another portion of the applicants, all features associated with those applicants may have contributed significantly to their predictions. Finally, the model updating system updates the machine learning model based on the global sparsity metric. Updating the model may include training a simpler model using the features that contributed significantly to predictions. For example, the model updating system may train a first new model for the first portion of the applicants. The first new model may be trained to predict program admissions for the first portion of the applicants based on their scores and references. The model updating system may train a second new model for the second portion of the applicants. The second new model may be trained to predict program admissions for the second portion of the applicants based on their scores and attributes.

In particular, the model updating system may use a machine learning model to generate predictions based on entries and features. For example, the model updating system may input, into a machine learning model, a dataset including a plurality of entries, with each entry including a corresponding plurality of features, to obtain a plurality of predictions. In some embodiments, the machine learning model may be trained to generate predictions for entries based on corresponding features. For example, the machine learning model may be trained to predict program admissions for applicants based on various features, such as application materials, scores, attributes, references, and other features. The model updating system may input a dataset including the applicants and each applicant's corresponding features. The model updating system may receive, from the machine learning model, predictions of program admissions for the applicants.

The model updating system may determine how much each feature impacted each prediction. For example, the model updating system may generate, for each entry of the plurality of entries, a plurality of feature impact parameters indicating a relative impact of each feature on each prediction of the plurality of predictions. For example, the model updating system may generate, for each applicant, parameters indicating how much each feature impacted the applicant's prediction of admission. For example, for a first applicant, the feature impact parameters may indicate that the first applicant's scores impacted the prediction the most, followed by application materials, then attributes, and finally references. For a second applicant, the feature impact parameters may indicate that the second applicant's scores and application materials impacted the prediction equally, while attributes and references did not impact the prediction. For a third applicant, the feature impact parameters may indicate that only the scores impacted the prediction, and so on.

The model updating system may determine a cutoff for assessing which features impacted the predictions. For example, the model updating system may determine a feature impact threshold for assessing which features of the corresponding plurality of features have contributed to each prediction. For example, the threshold may indicate a percentage, portion, or other cutoff below which a feature is not considered to have impacted a prediction significantly. For example, if a feature (e.g., references) has a feature impact parameter that falls below the threshold, the feature may not be considered to significantly impact the prediction. Determining the feature impact threshold may include modifying the dataset to include an additional feature for each entry, where the values for the additional features are randomly generated, and generating, for each additional entry, a corresponding additional feature impact parameter indicating a relative impact of a corresponding additional feature on each prediction. For example, the additional feature may be included as “noise.” The model updating system may determine the feature impact threshold based on an additional feature impact parameter. For example, the model updating system may set the feature impact threshold equal to an average of the additional feature impact parameters, as a highest additional feature impact parameter, or at another level based on the additional feature impact parameters.

The model updating system may then determine which features significantly impacted the prediction. For example, the model updating system may generate, using the plurality of feature impact parameters and the feature impact threshold, a sparsity metric for each prediction. In some embodiments, the sparsity metric indicates which features of the corresponding plurality of features have relative impacts that meet the feature impact threshold for the prediction. For example, the model updating system may compare each feature impact parameter with the feature impact threshold. The sparsity metric may indicate which features contributed significantly to the prediction. For example, the sparsity metric may indicate that a particular applicant's scores and application materials contributed significantly to a prediction of whether that application would be admitted to the program. In some embodiments, the system generates a global sparsity metric for the machine learning model. The global sparsity metric may indicate, for the plurality of predictions, the features having relative impacts that meet the feature impact threshold. The global sparsity metric may indicate trends of the feature impact parameters across the dataset. For example, the global sparsity metric may indicate that for a first portion of the applicants, scores and references contributed significantly to their predictions, while for a second portion of the applicants, scores and attributes contributed significantly to their predictions. In yet another portion of the applicants, all features associated with those applicants may have contributed significantly to their predictions.

The model updating system may update the machine learning model based on the features impacting the predictions. For example, the model updating system may update the machine learning model based on the global sparsity metric. Updating the model may include training a simpler model using the features that contributed significantly to predictions. For example, the model updating system may train a first new model for the first portion of the applicants, where the first new model is trained to predict program admissions for the first portion of the applicants based on their scores and references. The model updating system may train a second new model for the second portion of the applicants, where the second new model is trained to predict program admissions for the second portion of the applicants based on their scores and attributes.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for updating machine learning models based on the impact of features on predictions, in accordance with one or more embodiments.

FIG. 2 illustrates an exemplary machine learning model, in accordance with one or more embodiments.

FIG. 3 illustrates a data structure for input into a machine learning model, in accordance with one or more embodiments.

FIG. 4 illustrates a data structure representing impacts of features on predictions, in accordance with one or more embodiments.

FIG. 5 illustrates data structures representing new impacts of features on new predictions, in accordance with one or more embodiments.

FIG. 6 illustrates a computing device, in accordance with one or more embodiments.

FIG. 7 shows a flowchart of the process for updating machine learning models based on the impact of features on predictions, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

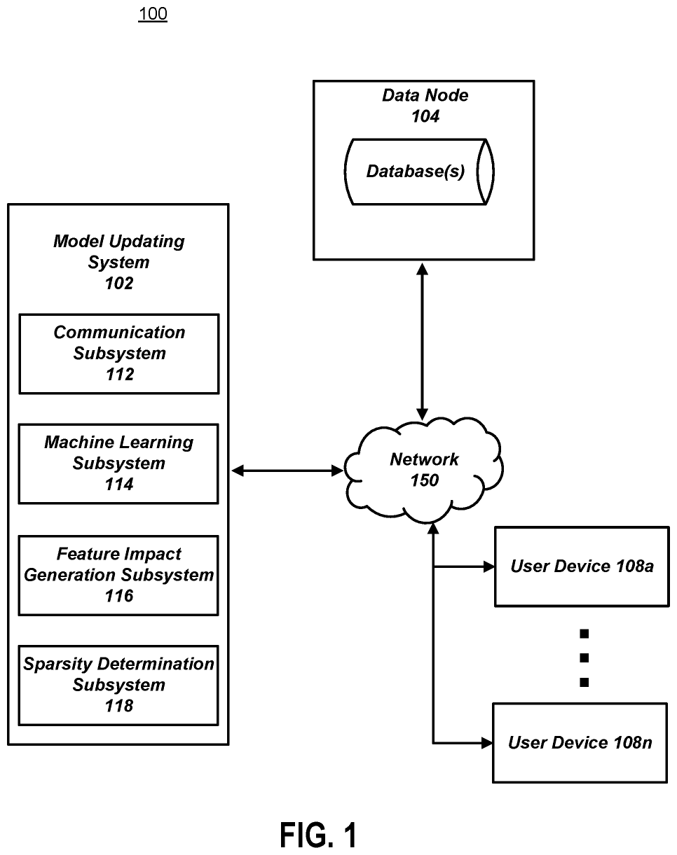

FIG. 1 shows an illustrative system 100 for updating machine learning models based on the impact of features on predictions, in accordance with one or more embodiments. System 100 may include model updating system 102, data node 104, and user devices 108a-108n. Model updating system 102 may include communication subsystem 112, machine learning subsystem 114, feature impact generation subsystem 116, sparsity determination subsystem 118, and/or other subsystems. In some embodiments, only one user device may be used while in other embodiments multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smartphones, and/or other computing devices used by end users). User devices 108a-108n may output (e.g., via a graphical user interface) run applications, output communications, receive inputs, or perform other actions.

Model updating system 102 may execute instructions for updating machine learning models based on the impact of features on predictions. Model updating system 102 may include software, hardware, or a combination of the two. For example, communication subsystem 112 may include a network card (e.g., a wireless network card and/or a wired network card) that is associated with software to drive the card. In some embodiments, model updating system 102 may be a physical server or a virtual server that is running on a physical computer system. In some embodiments, model updating system 102 may be configured on a user device (e.g., a laptop computer, a smart phone, a desktop computer, an electronic tablet, or another suitable user device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, model updating system 102 and data node 104 may reside on the same hardware and/or the same virtual server/computing device. Network 150 may be a local area network, a wide area network (e.g., the Internet), or a combination of the two.

Model updating system 102 (e.g., machine learning subsystem 114) may include one or more machine learning models. For example, one or more machine learning models may be trained to generate predictions for entries based on corresponding features. Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include entries with corresponding features and corresponding output labels for the entries. In some embodiments, machine learning subsystem 114 may access one or more machine learning models. For example, machine learning subsystem 114 may access the machine learning models on data node 104 or on user devices 108a-108n. In some embodiments, the machine learning models may be trained to generate predictions for the entries based on the features.

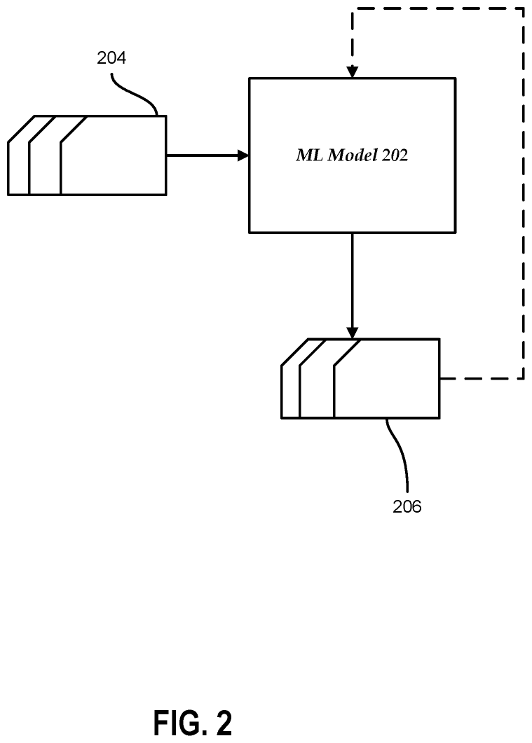

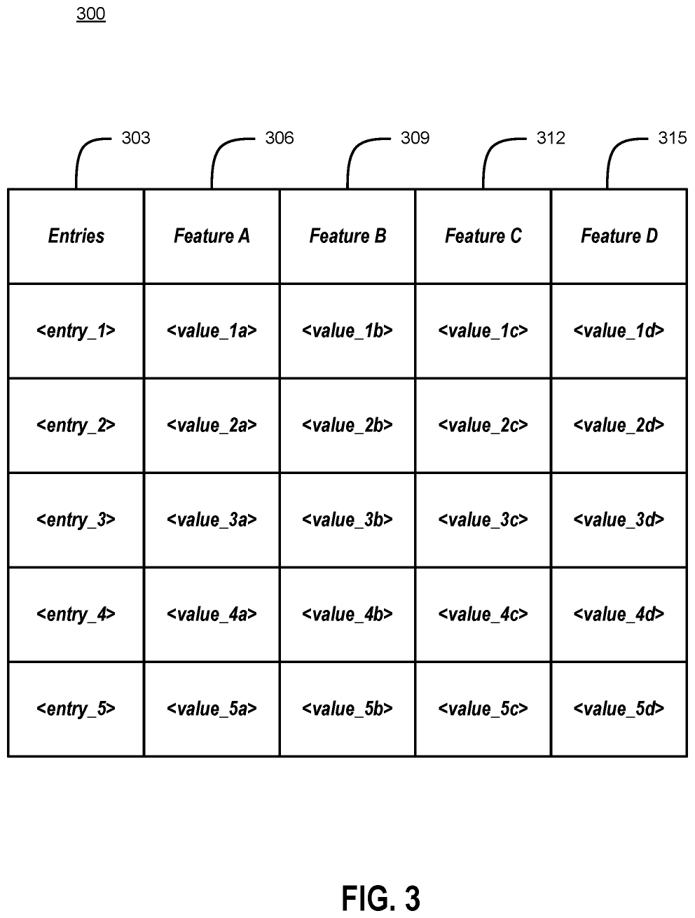

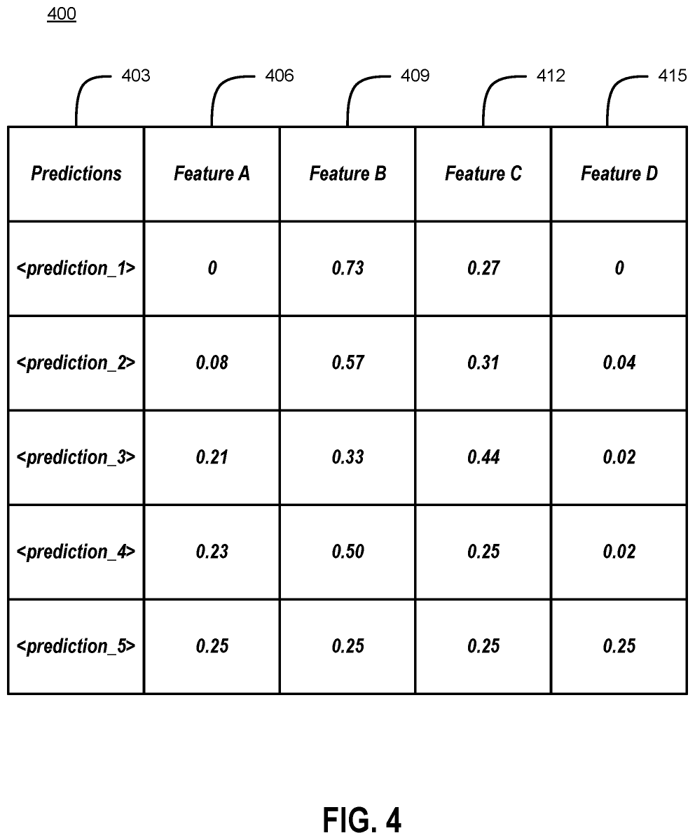

FIG. 2 illustrates an exemplary machine learning model 202, in accordance with one or more embodiments. The machine learning model may have been trained using features associated with entries, such as application materials, scores, applicant attributes, references, or other features associated with applicants for admission to a particular program. The machine learning model may have been trained to predict whether the applicants would be admitted to the program based on the features associated with the applicants. In some embodiments, machine learning model 202 may be included in machine learning subsystem 114 or may be associated with machine learning subsystem 114. Machine learning model 202 may take input 204 (e.g., entries and corresponding features, as described in greater detail with respect to FIG. 3) and may generate outputs 206 (e.g., predictions, as described in greater detail with respect to FIG. 4). In some embodiments, the outputs may further include feature impact parameters, as described in greater detail with respect to FIG. 4. The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Model updating system 102 may input a dataset into a machine learning model (e.g., machine learning model 202, as shown in FIG. 2) trained to generate predictions for entries based on features. The dataset may include entries with each entry including a number of features. For example, the dataset may include program applicants, and each applicant may be associated with a number of features, such as application materials, scores, applicant attributes, references, or other features. Model updating system 102 may generate feature impact parameters indicating a relative impact of each feature on each prediction. For example, the feature impact parameters may indicate the impact of an applicant's scores on a prediction of whether they will be admitted to the program, as well as the impact of the applicant's application materials on the prediction, and so on. The model updating system 102 may then determine a feature impact threshold for assessing which features have contributed to each prediction. For example, the feature impact threshold may be a level below which a feature is not considered to have impacted the prediction for a particular applicant.

Model updating system 102 may then determine which features significantly impacted the prediction. For example, model updating system 102 may generate a sparsity metric for each prediction using the feature impact parameters and the feature impact threshold. Model updating system 102 may compare each feature impact parameter with the feature impact threshold. The sparsity metric may indicate which features contributed significantly to the prediction. For example, the sparsity metric may indicate that a particular applicant's scores and application materials contributed significantly to a prediction of whether that applicant would be admitted to the program. Model updating system 102 may generate a global sparsity metric for the machine learning model. The global sparsity metric may indicate trends of the feature impact parameters across the dataset. For example, the global sparsity metric may indicate that for a first portion of the applicants, scores and references contributed significantly to their predictions, while for a second portion of the applicants, scores and attributes contributed significantly to their predictions. In yet another portion of the applicants, all features associated with those applicants may have contributed significantly to their predictions. Finally, model updating system 102 may update the machine learning model based on the global sparsity metric. Updating the model may include training a simpler model using the features that contributed significantly to predictions.

Returning to FIG. 1, machine learning subsystem 114 may input, into a machine learning model (e.g., machine learning model 202, as shown in FIG. 2), a dataset that includes a plurality of entries with each entry comprising a corresponding plurality of features to obtain a plurality of predictions. In some embodiments, the machine learning model is trained to generate predictions for entries based on corresponding features, as discussed above in relation to FIG. 2. FIG. 3 illustrates a data structure 300 for inputting data into a machine learning model. Data structure 300 may include entries 303, as well as a plurality of features, including feature 306, feature 309, feature 312, and feature 315. In some embodiments, data structure 300 may be a subset of a larger data structure. Entries 303 may include a plurality of applicants for admission to a particular program. Features 306 may be application materials associated with the applicants, feature 309 may be scores, feature 312 may be applicant attributes, and feature 315 may be references. Based on data structure 300, the machine learning model (e.g., machine learning model 202) generates a plurality of predictions for entries 303 (e.g., applicants) based on features 306, 309, 312, and 315 (e.g., materials, scores, attributes, and references).

Model updating system 102 (e.g., feature impact generation subsystem 116) generates, for each entry of the plurality of entries, a plurality of feature impact parameters. In some embodiments, feature impact parameters are a metric for indicating a relative impact of each feature of the corresponding plurality of features on each prediction of the plurality of predictions. Feature impact generation subsystem 116 may use a number of techniques to generate the feature impact parameters. As an example, feature impact generation subsystem 116 may use a local linear model, where coefficients determine the estimated impact of each feature. If a feature coefficient is non-zero, then feature impact generation subsystem 116 may determine the feature impact parameter of the feature according to the sign and magnitude of the coefficient. As another example, feature impact generation subsystem 116 may perturb the input around a feature's neighborhood and assess how the machine learning model's predictions behave. Feature impact generation subsystem 116 may then weigh these perturbed data points by their proximity to the original example and learn an interpretable model on those and the associated predictions. As another example, feature impact generation subsystem 116 may randomly generate entries surrounding a particular entry. Feature impact generation subsystem 116 may then use the machine learning model to generate predictions of the generated random entries. Feature impact generation subsystem 116 may then construct a local regression model using the generated random entries and their generated predictions from the machine learning model. Finally, the coefficients of the regression model may indicate the contribution of each feature to the prediction of the particular entry according to the machine learning model. In some embodiments, feature impact generation subsystem 116 may use these or other techniques to generate the feature impact parameters for the entries based on the features.

FIG. 4 illustrates a data structure 400 representing impacts of features on predictions. Data structure 400 may include predictions 403 and feature impact parameters for features associated with predictions 403. In some embodiments, data structure 400 may be a subset of a larger data structure. In some embodiments, predictions 403 may represent predictions for entries 303, as shown in FIG. 3. Feature 406, feature 409, feature 412, and feature 415 may correspond to feature 306, feature 309, feature 312, and feature 315, as shown in FIG. 3. In some embodiments, data structure 400 may include feature impact parameters indicating the impacts of feature 406, feature 409, feature 412, and feature 415 on predictions 403. In some embodiments, predictions 403 may be binary (e.g., yes or no, approved or not approved, admitted or not admitted, etc.), a percentage (e.g., 57% likely to be approved, 10% likely to be admitted, etc.), a portion (e.g., 0.33, ⅓, etc.), or in some other form. FIG. 4 shows the feature impact parameters of feature 406, feature 409, feature 412, and feature 415 in the form of relative impact on predictions 403, normalized to one.

For example, for the first entry, data structure 400 shows that feature 406 and feature 415 did not impact <prediction_1>, while <prediction_1> was based 73% on feature 409 and 27% on feature 412. The first entry may represent a first applicant, who is not predicted to be admitted to a particular program. Data structure 400 may indicate that the prediction that the first applicant is not predicted to be admitted to the program is based mostly (e.g., 73%) on the first applicant's scores and partially (e.g., 27%) on the first applicant's attributes and is not based on the first applicant's application materials or references. In another example, the second entry may represent a second applicant, who is predicted to be admitted to the program. Data structure 400 may indicate that the prediction that the second applicant is predicted to be admitted to the program is based partially (e.g., 8%) on the second applicant's application materials, partially (e.g., 57%) on the second applicant's scores, partially (e.g., 31%) on the second applicant's attributes, and partially (e.g., 4%) on the second applicant's references.

In some embodiments, feature impact generation subsystem 116 determines a feature impact threshold for assessing which features of the corresponding plurality of features have contributed to each prediction. For example, the threshold may indicate a percentage, portion, or other cutoff below which a feature is not considered to have impacted a prediction significantly. For example, if a feature (e.g., references) has a feature impact parameter that falls below the threshold, the feature may not be considered to significantly impact the prediction. In some embodiments, the feature impact threshold may be set to zero, such that any feature having a feature impact parameter above zero for a particular prediction is considered to impact the prediction. In some embodiments, the feature impact threshold may be predetermined or entered manually at a particular level. For example, a higher feature impact threshold (e.g., 0.2) limits the number of features that are considered to impact predictions, whereas a lower feature impact threshold (0.05) expands the number of features that are considered to impact predictions.

In some embodiments, determining the feature impact threshold may include inputting a modified dataset including “noise” into the machine learning model (e.g., machine learning model 202, as shown in FIG. 2). “Noise” may refer to errors or other generally unwanted behaviors within input data. Feature impact generation subsystem 116 may modify the dataset (e.g., data set 300, as shown in FIG. 3) to include an additional feature for each entry of the plurality of entries (e.g., entries 303), where the values for the additional features are randomly generated. For example, the entries for the additional feature may be the “noise.” Feature impact generation subsystem 116 may generate, for each entry of the additional plurality of entries, a corresponding additional feature impact parameter indicating a relative impact of a corresponding additional feature on each prediction of the plurality of predictions. Feature impact generation subsystem 116 may determine the feature impact threshold based on the additional feature impact parameters. For example, feature impact generation subsystem 116 may set the feature impact threshold equal to an average of the additional feature impact parameters, as a highest additional feature impact parameter, or at another level based on the additional feature impact parameters.

Model updating system 102 (e.g., sparsity determination subsystem 118) generates, using the plurality of feature impact parameters and the feature impact threshold, a sparsity metric for each prediction. The sparsity metric may indicate which features contributed significantly to the prediction. For example, the sparsity metric may indicate that a particular applicant's scores and application materials contributed significantly to a prediction of whether that applicant would be admitted to the program. In some embodiments, the sparsity metric indicates which features of the corresponding plurality of features have relative impacts that meet the feature impact threshold for the prediction. In some embodiments, generating the sparsity metric for each prediction involves determining whether a feature impact parameter for each feature associated with the prediction meets the feature impact threshold. For example, the sparsity metric of each feature for each entry may be a “yes” or “no” or may be a value of zero or one to indicate whether the respective feature impact parameter meets the feature impact threshold. Based on a first subset of feature impact parameters for a first subset of features meeting the feature impact threshold, sparsity determination subsystem 118 may determine that the first subset of features contributes to the prediction. For example, sparsity determination subsystem 118 may assign the first subset of features a value of one to indicate that the first subset of features contributes to the prediction. Based on a second subset of feature impact parameters for a second subset of features not meeting the feature impact threshold, sparsity determination subsystem 118 may determine that the second subset of features does not contribute to the prediction. For example, sparsity determination subsystem 118 may assign the second subset of features a value of zero to indicate that the first subset of features does not contribute to the prediction. Sparsity determination subsystem 118 may generate the sparsity metric for the prediction to include the first subset of features and exclude the second subset of features.

In some embodiments, feature impact generation subsystem 116 may adjust the feature impact threshold and sparsity determination subsystem 118 may generate a new set of sparsity metrics. For example, for a first feature impact threshold (e.g., 1%), sparsity determination subsystem 118 may generate a first set of sparsity metrics for the features for each entry. For a second feature impact threshold (e.g., 2%), sparsity determination subsystem 118 may generate a second set of sparsity metrics for the features for each entry, and so on. Sparsity determination subsystem 118 may continue to generate sparsity metrics for a number of different feature impact thresholds. Sparsity determination subsystem 118 may graph the sparsity metrics for each different feature impact threshold to generate a curve. In some embodiments, machine learning subsystem 114 may compare machine learning models based on a comparison of the areas under the curves. Machine learning subsystem 114 may select a machine learning model based on, for example, minimizing or maximizing the area under the curve.

In some embodiments, sparsity determination subsystem 118 generates a global sparsity metric for the machine learning model. The global sparsity metric may indicate, for the predictions, the features having relative impacts that meet the feature impact threshold. For example, sparsity determination subsystem 118 may generate a data structure with the same dimensionality as data structure 400 and populate the data structure with the sparsity metrics of each feature for each prediction. The resulting data structure may be populated with zeroes and ones indicating whether each feature contributes to each prediction. In some embodiments, sparsity determination subsystem 118 may organize or sort the entries in the data structure according to trends, patterns, or other criteria. In some embodiments, sparsity determination subsystem 118 may divide the data structure into subsets according to trends, patterns, or other criteria.

In some embodiments, the global sparsity metric indicates a number of times each feature met the feature impact threshold. The global sparsity metric may indicate which features most commonly met the feature impact threshold. The global sparsity metric may indicate which features impacted the predictions for a first subset of the dataset (e.g., a first population) versus which features impacted the predictions for a second subset (e.g., a second population), and so on. In some embodiments, the global sparsity metric may indicate other trends or patterns of the sparsity metrics for the predictions (e.g., a typical prediction is impacted by three features or a first population of the dataset is impacted by first and second features). For example, the global sparsity metric may indicate that for a first portion of the applicants, scores and references contributed significantly to their predictions, while for a second portion of the applicants, scores and attributes contributed significantly to their predictions. In yet another portion of the applicants, all features associated with those applicants may have contributed significantly to their predictions.

In some embodiments, generating the global sparsity metric involves applying a function to sparsity metrics for the plurality of features across the plurality of predictions. For example, sparsity determination subsystem 118 may define a function and pass each column or each row of data (e.g., of data structure 400, as shown in FIG. 4) through the function. In some embodiments, sparsity determination subsystem 118 may map the function for the sparsity metrics to generate the global sparsity metrics. In some embodiments, sparsity determination subsystem 118 may graph the function for the sparsity metrics to generate the global sparsity metrics.

Machine learning subsystem 114 updates the machine learning model based on the global sparsity metric. For example, machine learning subsystem 114 may update the machine learning model (e.g., machine learning model 202, as shown in FIG. 2) based on trends, patterns, or other aspects of the global sparsity metric. In some embodiments, updating the machine learning model may involve retraining the machine learning model. In some embodiments, updating the machine learning model may involve training a new machine learning model. In some embodiments, updating the machine learning model may involve training multiple new machine learning models. For example, machine learning subsystem 114 may train a first new model for the first portion of the applicants. The first new model may be trained to predict program admissions for the first portion of the applicants based on their scores and references. Machine learning subsystem 114 may train a second new model for the second portion of the applicants. The second new model may be trained to predict program admissions for the second portion of the applicants based on their scores and attributes. In some embodiments, updating the machine learning model may be performed to minimize a number of features used for the dataset. In some embodiments, updating the machine learning model may be performed to minimize a number of features used for each prediction. In some embodiments, updating the machine learning model may be performed to minimize a number of features used for a particular subset (e.g., population) of the dataset. In some embodiments, updating the machine learning model may be performed for another goal.

In some embodiments, updating the machine learning model involves selecting one or more hyperparameters associated with the machine learning model. A hyperparameter is a parameter whose value is used to control the learning process of a machine learning model. Hyperparameters may include a learning rate of a machine learning model, a number of branches in a decision tree, a number of clusters in a clustering algorithm, or other parameters. Machine learning subsystem 114 may then update the one or more hyperparameters based on the global sparsity metric. For example, machine learning subsystem 114 may select a hyperparameter dictating a number of branches in a decision tree and may update the hyperparameter, based on the global sparsity metric, such that the decision tree has fewer branches.

In some embodiments, updating the machine learning model involves selecting, based on the global sparsity metric, one or more features of the plurality of features and training a new machine learning model based on the one or more features. For example, machine learning subsystem 114 may select one or more features having feature impact parameters that meet a feature impact threshold. In some embodiments, machine learning subsystem 114 may select one or more features according to other criteria, based on the global sparsity metric. For example, machine learning subsystem 114 may select one or more features having feature impact parameters that meet the feature impact threshold for the greatest number of predictions. Machine learning subsystem 114 may select a predetermined number of features having feature impact parameters that meet the feature impact threshold. Machine learning subsystem 114 may select one or more features having the highest feature impact parameters. Machine learning subsystem 114 may train a new machine learning model using the one or more features and may exclude all other features of the plurality of features.

In some embodiments, sparsity determination subsystem 118 may generate, based on a feature of the plurality of features, a plurality of subsets of the dataset. For example, a first subset of the plurality of subsets may be associated with a first category of the feature different from a second category of the feature associated with a second subset of the plurality of subsets. A category of a feature may be a common characteristic of the feature shared by a number of the entries. For example, a category may be a particular type of application materials, a range of scores, a certain applicant attribute, a type of reference, or other categories. A first subset of the dataset may be a subset of entries having scores within a first range of scores. The second subset of the dataset may include entries having scores within a second range of scores, and so on.

Sparsity determination subsystem 118 may then generate a plurality of sparsity metrics for the plurality of subsets. Sparsity determination subsystem 118 may determine that one or more subsets of the plurality of subsets of the dataset have similar sparsity metrics to one or more other subsets of the plurality of subsets of the dataset. For example, the first subset of the dataset (e.g., a subset of entries having scores within a first range of scores) may have similar sparsity metrics to the second subset of the dataset (e.g., a subset of entries having scores within a second range of scores). The sparsity metrics for the first and second datasets may be dissimilar to sparsity metrics for other subsets within the dataset (e.g., subsets of entries having scores within other ranges of scores). Machine learning subsystem 114 may train a new machine learning model based on the one or more subsets and the one or more other subsets. For example, machine learning subsystem 114 may train a new machine learning model for the first and second subsets of the dataset based on the similar sparsity metrics across the first and second datasets.

Sparsity determination subsystem 118 may determine that one or more subsets of the plurality of subsets of the dataset have different sparsity metrics from one or more other subsets of the plurality of subsets of the dataset. For example, the sparsity metrics for the first and second datasets may be dissimilar to sparsity metrics for other subsets within the dataset (e.g., subsets of entries having scores within other ranges of scores). Machine learning subsystem 114 may train, based on the different sparsity metrics, one or more new machine learning models to generate new predictions based on the one or more subsets and the one or more other subsets of the plurality of subsets of the dataset. For example, machine learning subsystem 114 may train a first new machine learning model for the first and second subsets having similar sparsity metrics. Machine learning subsystem 114 may train a second new machine learning model for a third subset of the dataset having dissimilar sparsity metrics from the first and second subsets. In some embodiments, machine learning subsystem 114 may train a third new machine learning model for a group of subsets of the dataset having dissimilar sparsity metrics from the first, second, and third subsets but similar sparsity metrics to each other, and so on.

In some embodiments, machine learning subsystem 114 may identify one or more features most commonly meeting the feature impact threshold within each subset of the plurality of subsets of the dataset and may train a new machine learning model based on the one or more features. For example, machine learning subsystem 114 may identify a first group of features most commonly meeting the feature impact threshold within the first and second subsets of the plurality of subsets of the dataset and may train a first new machine learning model based on the first group of features. Machine learning subsystem 114 may identify a second group of features most commonly meeting the feature impact threshold within the third subset of the dataset and may train a second new machine learning model based on the second group of features, and so on.

In some embodiments, machine learning subsystem 114 may determine that a received entry is associated with the first category. For example, model updating system 102 (e.g., communication subsystem 112) may receive a new entry of an applicant to a program, and machine learning subsystem 114 may determine that a score associated with the applicant falls within a third range corresponding to the third subset of the dataset. Machine learning subsystem 114 may then select a corresponding machine learning model for the received entry based on the first category. For example, machine learning subsystem 114 may select a machine learning model corresponding to the third subset of the dataset. Machine learning subsystem 114 may then input the received entry into the corresponding machine learning model to generate a prediction.

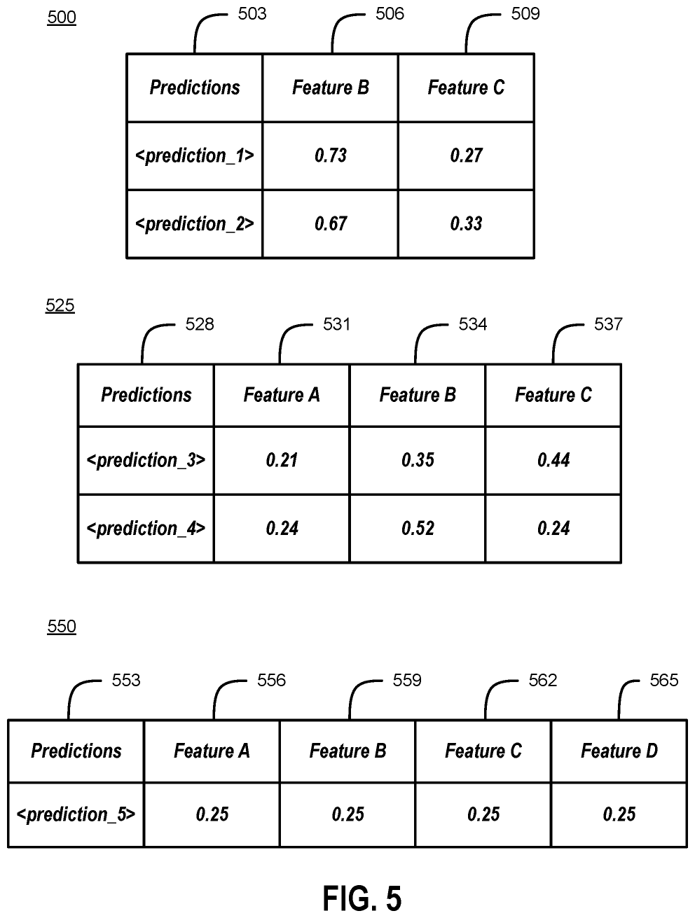

FIG. 5 illustrates data structure 500 representing new impacts of features on new predictions, in accordance with one or more embodiments. Data structure 500 includes predictions 503 and feature 506 and feature 509. In some embodiments, data structure 500 may represent a subset of data structure 400, as shown in FIG. 4. For example, predictions 503 may be a subset of the dataset of data structure 400 corresponding to a first category based on features B or C falling into a first category for the first two entries. For example, feature B may be a score falling within a first range for the first and second entries. Machine learning subsystem 114 may thus determine that the first and second entries constitute a first subset of the dataset. In some embodiments, predictions 503 may be a subset of the dataset for which features B and C meet a feature impact threshold. In some embodiments, machine learning subsystem 114 may train a new machine learning model for the first subset of the dataset (e.g., predictions 503) using feature 506 and feature 509.

FIG. 5 further illustrates data structure 525 representing new impacts of features on new predictions, in accordance with one or more embodiments. Data structure 525 includes predictions 528 and feature 531, feature 534, and feature 537. In some embodiments, data structure 525 may represent a subset of data structure 400, as shown in FIG. 4. For example, predictions 528 may be a subset of the dataset of data structure 400 corresponding to a second category based on features A, B, or C falling into a second category for the third and fourth entries. For example, feature B may be a score falling within a second range for the third and fourth entries. Machine learning subsystem 114 may thus determine that the third and fourth entries constitute a second subset of the dataset. In some embodiments, predictions 528 may be a subset of the dataset for which features A, B, and C meet a feature impact threshold. In some embodiments, machine learning subsystem 114 may train another new machine learning model for the second subset of the dataset (e.g., predictions 528) using feature 531, feature 534, and feature 537.

FIG. 5 further illustrates data structure 550 representing new impacts of features on new predictions, in accordance with one or more embodiments. Data structure 550 includes predictions 553 and feature 556, feature 559, feature 562, and feature 565. In some embodiments, data structure 550 may represent a subset of data structure 400, as shown in FIG. 4. For example, predictions 553 may be a subset of the dataset of data structure 400 corresponding to a third category based on features A, B, C, or D falling into a third category for the fifth entry. For example, feature B may be a score falling within a third range for the fifth entry. Machine learning subsystem 114 may thus determine that the fifth entry constitutes a third subset of the dataset. In some embodiments, prediction 553 may be a subset of the dataset for which features A, B, C, and D meet a feature impact threshold. In some embodiments, machine learning subsystem 114 may train another new machine learning model for the third subset of the dataset (e.g., predictions 553) using feature 556, feature 559, feature 562, and feature 565.

Returning to FIG. 1, machine learning subsystem 114 may determine an initial accuracy metric for the machine learning model. For example, machine learning subsystem 114 may measure the number of correct predictions made by the machine learning model in relation to the total number of predictions made. Machine learning subsystem 114 may calculate it by dividing the number of correct predictions by the total number of predictions. Machine learning subsystem 114 may train a new machine learning model using a modified dataset comprising entries for a subset of the plurality of features to obtain new predictions, as discussed above in relation to FIG. 5. Machine learning subsystem 114 may then determine a modified accuracy metric for the new machine learning model based on the modified dataset. Machine learning subsystem 114 may determine whether an accuracy difference between the initial accuracy metric and the modified accuracy metric meets an accuracy threshold. For example, machine learning subsystem 114 may determine whether the modified accuracy metric is within a threshold amount (e.g., 5%) of the initial accuracy metric. In some embodiments, machine learning subsystem 114 may determine whether the modified accuracy metric meets an accuracy threshold (e.g., 90%). In some embodiments, machine learning subsystem 114 may use other means of assessing the accuracy of the modified machine learning model. Based on the accuracy difference meeting the accuracy threshold, machine learning subsystem 114 may replace the machine learning model with the new machine learning model.

In some embodiments, machine learning subsystem 114 may further determine an initial prediction speed for the machine learning model. Machine learning subsystem 114 may determine a modified prediction speed for the new machine learning model based on the modified dataset. Machine learning subsystem 114 may then determine whether a prediction speed difference between the initial prediction speed and the modified prediction speed meets a prediction speed threshold. For example, machine learning subsystem 114 may determine whether the modified prediction speed is within a threshold amount (e.g., 5%) of the initial prediction speed. In some embodiments, machine learning subsystem 114 may determine whether the modified prediction speed meets a speed threshold (e.g., 1 second). In some embodiments, machine learning subsystem 114 may use other means of assessing the speed of the modified machine learning model. Based on the accuracy difference meeting the accuracy threshold and the prediction speed difference meeting the prediction speed threshold, machine learning subsystem 114 may replace the machine learning model with the new machine learning model.

### Computing Environment

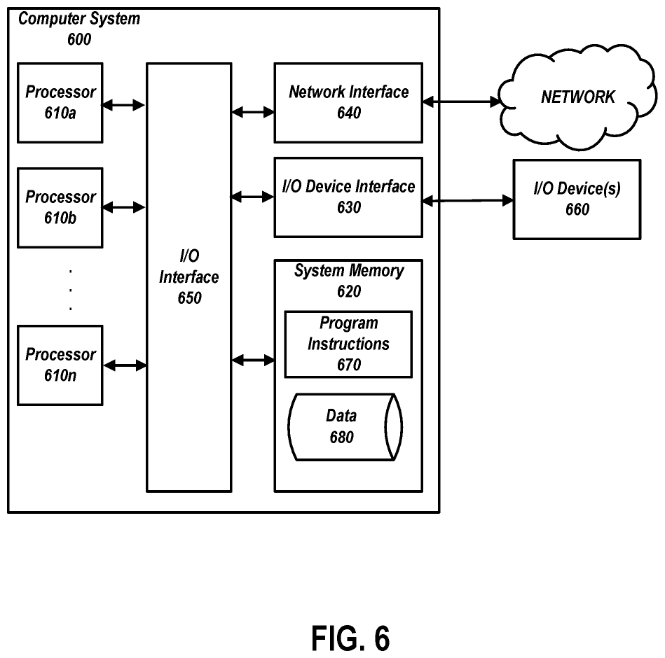

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

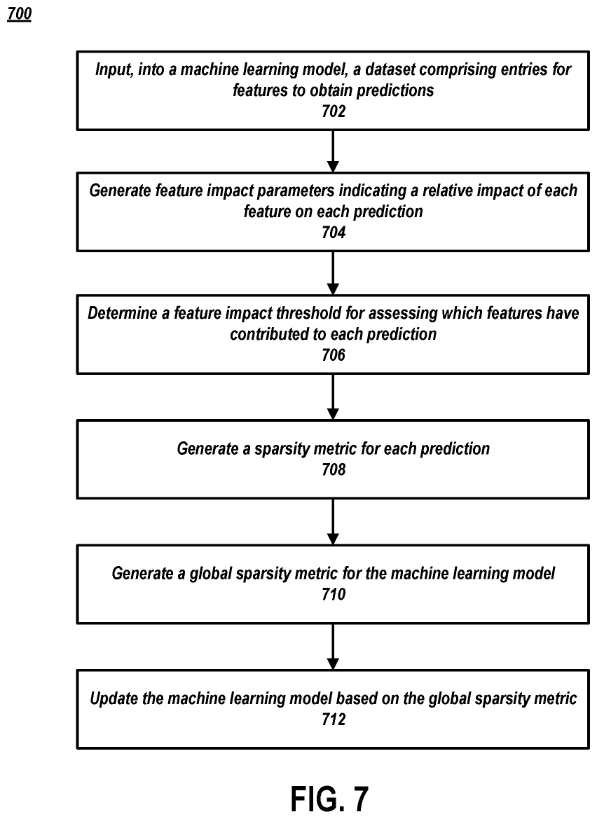

FIG. 7 shows a flowchart of the process 700 for updating machine learning models based on the impact of features on predictions, in accordance with one or more embodiments. For example, the system may use process 700 (e.g., as implemented on one or more system components described above) to determine which features contribute to a given prediction and update the model accordingly.

At 702, process 700 (e.g., using one or more of processors 610a-610n) inputs, into a machine learning model, a dataset comprising entries for features to obtain predictions. The dataset may include a plurality of entries with each entry including a corresponding plurality of features. The machine learning model may be trained to generate predictions for entries based on corresponding features. In some embodiments, process 700 may obtain the dataset from system memory 620, via the network, or elsewhere. Process 700 may train the machine learning model using one or more of processors 610a-610n or may retrieve the trained machine learning model from system memory 620, via the network, or elsewhere.

At 704, process 700 (e.g., using one or more of processors 610a-610n) generates feature impact parameters indicating a relative impact of each feature on each prediction. In some embodiments, process 700 may generate the feature impact parameters using one or more of processors 610a-610n.

At 706, process 700 (e.g., using one or more of processors 610a-610n) determines a feature impact threshold for assessing which features have contributed to each prediction. For example, process 700 may determine the feature impact threshold by modifying the dataset to include an additional feature for each entry, where values for the additional features are randomly generated. Process 700 may then generate, for each entry, a corresponding additional feature impact parameter indicating a relative impact of a corresponding additional feature on each prediction. Process 700 may determine the feature impact threshold based on a highest additional feature impact parameter. In some embodiments, process 700 may determine the feature impact threshold using one or more of processors 610a-610n.

At 708, process 700 (e.g., using one or more of processors 610a-610n) generates a sparsity metric for each prediction. The sparsity metric may indicate which features of the corresponding plurality of features have relative impacts that meet the feature impact threshold for the prediction. In some embodiments, process 700 may determine the sparsity metric using one or more of processors 610a-610n.

At 710, process 700 (e.g., using one or more of processors 610a-610n) generates a global sparsity metric for the machine learning model. For example, generating the global sparsity metric may include applying a function to sparsity metrics for the features across the predictions. In some embodiments, process 700 may generate the global sparsity metric using one or more of processors 610a-610n.

At 712, process 700 (e.g., using one or more of processors 610a-610n) updates the machine learning model based on the global sparsity metric. For example, updating the machine learning model may include selecting one or more hyperparameters associated with the machine learning model and adjusting the one or more hyperparameters based on the global sparsity metric. Updating the machine learning model may include selecting, based on the global sparsity metric, one or more features and training a new machine learning model based on the one or more features. In some embodiments, process 700 may update the machine learning model using one or more of processors 610a-610n.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising inputting, into a machine learning model, a dataset comprising a plurality of entries with each entry comprising a plurality of features to obtain a plurality of predictions, wherein the machine learning model is trained to generate predictions for entries based on features, generating, for each entry of the plurality of entries, a plurality of feature impact parameters indicating a relative impact of each feature of the plurality of features on each prediction of the plurality of predictions, determining a feature impact threshold for assessing which features of the plurality of features have contributed to each prediction, generating, using the plurality of feature impact parameters and the feature impact threshold, a sparsity metric for each prediction, wherein the sparsity metric indicates which features of the plurality of features have relative impacts that meet the feature impact threshold for the prediction; generating a global sparsity metric for the machine learning model, and updating the machine learning model based on the global sparsity metric.
2. The method of any one of the preceding embodiments, wherein determining the feature impact threshold comprises modifying the dataset to include an additional feature for each entry of the plurality of entries, wherein values for the additional features are randomly generated, generating, for each entry of the additional plurality of entries, a corresponding additional feature impact parameter indicating a relative impact of a corresponding additional feature on each prediction of the plurality of predictions, and determining the feature impact threshold based on a highest additional feature impact parameter.
3. The method of any one of the preceding embodiments, wherein generating the sparsity metric for each prediction comprises determining whether a feature impact parameter for each feature associated with the prediction meets the feature impact threshold, based on a first subset of the plurality of feature impact parameters for a first subset of features associated with the prediction meeting the feature impact threshold, determining that the first subset of features contributes to the prediction, based on a second subset of the plurality of feature impact parameters for a second subset of features associated with the prediction not meeting the feature impact threshold, determining that the second subset of features does not contribute to the prediction; and generating the sparsity metric for the prediction to include the first subset of features and exclude the second subset of features.
4. The method of any one of the preceding embodiments, wherein generating the global sparsity metric comprises applying a function to sparsity metrics for the plurality of features across the plurality of predictions.
5. The method of any one of the preceding embodiments, further comprising generating, based on a feature of the plurality of features, a plurality of subsets of the dataset, wherein a first subset of the plurality of subsets is associated with a first category of the feature different from a second category of the feature associated with a second subset of the plurality of subsets, and generating a plurality of sparsity metrics for the plurality of subsets.
6. The method of any one of the preceding embodiments, further comprising determining that one or more subsets of the plurality of subsets of the dataset have similar sparsity metrics to one or more other subsets of the plurality of subsets of the dataset, and training a new machine learning model based on the one or more subsets and the one or more other subsets.
7. The method of any one of the preceding embodiments, further comprising determining that one or more subsets of the plurality of subsets of the dataset have different sparsity metrics from one or more other subsets of the plurality of subsets of the dataset, and training, based on the different sparsity metrics, one or more new machine learning models to generate new predictions based on the one or more subsets and the one or more other subsets of the plurality of subsets of the dataset.
8. The method of any one of the preceding embodiments, further comprising identifying one or more features most commonly meeting the feature impact threshold within each subset of the plurality of subsets of the dataset, and training a new machine learning model based on the one or more features.
9. The method of any one of the preceding embodiments, further comprising determining that a received entry is associated with the first category, and selecting a corresponding machine learning model for the received entry based on the first category.
10. The method of any one of the preceding embodiments, further comprising determining an initial accuracy metric for the machine learning model, training a new machine learning model using a modified dataset comprising entries for a subset of the plurality of features to obtain new predictions, determining a modified accuracy metric for the new machine learning model based on the modified dataset, determining whether an accuracy difference between the initial accuracy metric and the modified accuracy metric meets an accuracy threshold, and based on the accuracy difference meeting the accuracy threshold, replacing the machine learning model with the new machine learning model.
11. The method of any one of the preceding embodiments, further comprising determining an initial prediction speed for the machine learning model, determining a modified prediction speed for the new machine learning model based on the modified dataset, determining whether a prediction speed difference between the initial prediction speed and the modified prediction speed meets a prediction speed threshold, and based on the accuracy difference meeting the accuracy threshold and the prediction speed difference meeting the prediction speed threshold, replacing the machine learning model with the new machine learning model.
12. The method of any one of the preceding embodiments, wherein updating the machine learning model comprises selecting one or more hyperparameters associated with the machine learning model, and adjusting the one or more hyperparameters based on the global sparsity metric.
13. The method of any one of the preceding embodiments, wherein updating the machine learning model comprises selecting, based on the global sparsity metric, one or more features of the plurality of features, and training a new machine learning model based on the one or more features.
14. A tangible, non-transitory, machine-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.
17. A system comprising cloud-based circuitry for performing any of embodiments 1-13.

What is claimed is:

1. A system for updating machine learning models, the system comprising:
at least one processor, at least one memory, and computer-readable media having computer-executable instructions stored thereon, the computer-executable instructions, when executed by the at least one processor, causing the system to perform operations comprising:
inputting, into a machine learning model, a dataset comprising a plurality of entries with each entry comprising a corresponding plurality of features to obtain a plurality of predictions, wherein the machine learning model is trained to generate predictions for entries based on corresponding features;
generating, for each entry of the plurality of entries, a plurality of feature impact parameters indicating a relative impact of each feature of the corresponding plurality of features on each prediction of the plurality of predictions;
determining a feature impact threshold for assessing which features of the corresponding plurality of features have contributed to each prediction;
generating, using the plurality of feature impact parameters and the feature impact threshold, a sparsity metric for each prediction, wherein the sparsity metric indicates which features of the corresponding plurality of features have relative impacts that meet the feature impact threshold for the prediction;
generating a global sparsity metric for the machine learning model, the global sparsity metric indicating, for the plurality of predictions, the features having relative impacts that meet the feature impact threshold; and
updating the machine learning model based on the global sparsity metric.

2. A method comprising:
inputting, into a machine learning model, a dataset comprising a plurality of entries with each entry comprising a plurality of features to obtain a plurality of predictions, wherein the machine learning model is trained to generate predictions for entries based on features;
generating, for each entry of the plurality of entries, a plurality of feature impact parameters indicating a relative impact of each feature of the plurality of features on each prediction of the plurality of predictions;
determining a feature impact threshold for assessing which features of the plurality of features have contributed to each prediction;
generating, using the plurality of feature impact parameters and the feature impact threshold, a sparsity metric for each prediction, wherein the sparsity metric indicates which features of the plurality of features have relative impacts that meet the feature impact threshold for the prediction;
generating a global sparsity metric for the machine learning model; and
updating the machine learning model based on the global sparsity metric.

3. The method of claim 2, wherein determining the feature impact threshold comprises:
modifying the dataset to include an additional feature for each entry of the plurality of entries, wherein values for the additional features are randomly generated;
generating, for each entry of the additional plurality of entries, a corresponding additional feature impact parameter indicating a relative impact of a corresponding additional feature on each prediction of the plurality of predictions; and
determining the feature impact threshold based on a highest additional feature impact parameter.

4. The method of claim 2, wherein generating the sparsity metric for each prediction comprises:
determining whether a feature impact parameter for each feature associated with the prediction meets the feature impact threshold;
based on a first subset of the plurality of feature impact parameters for a first subset of features associated with the prediction meeting the feature impact threshold, determining that the first subset of features contributes to the prediction;
based on a second subset of the plurality of feature impact parameters for a second subset of features associated with the prediction not meeting the feature impact threshold, determining that the second subset of features does not contribute to the prediction; and
generating the sparsity metric for the prediction to include the first subset of features and exclude the second subset of features.

5. The method of claim 2, wherein generating the global sparsity metric comprises applying a function to sparsity metrics for the plurality of features across the plurality of predictions.

6. The method of claim 2, further comprising:
generating, based on a feature of the plurality of features, a plurality of subsets of the dataset, wherein a first subset of the plurality of subsets is associated with a first category of the feature different from a second category of the feature associated with a second subset of the plurality of subsets; and
generating a plurality of sparsity metrics for the plurality of subsets.

7. The method of claim 6, further comprising:
determining that one or more subsets of the plurality of subsets of the dataset have similar sparsity metrics to one or more other subsets of the plurality of subsets of the dataset; and
training a new machine learning model based on the one or more subsets and the one or more other subsets.

8. The method of claim 6, further comprising:
determining that one or more subsets of the plurality of subsets of the dataset have different sparsity metrics from one or more other subsets of the plurality of subsets of the dataset; and
training, based on the different sparsity metrics, one or more new machine learning models to generate new predictions based on the one or more subsets and the one or more other subsets of the plurality of subsets of the dataset.

9. The method of claim 6, further comprising:
identifying one or more features most commonly meeting the feature impact threshold within each subset of the plurality of subsets of the dataset; and
training a new machine learning model based on the one or more features.

10. The method of claim 6, further comprising:
determining that a received entry is associated with the first category; and
selecting a corresponding machine learning model for the received entry based on the first category.

11. The method of claim 2, further comprising:
determining an initial accuracy metric for the machine learning model;
training a new machine learning model using a modified dataset comprising entries for a subset of the plurality of features to obtain new predictions;
determining a modified accuracy metric for the new machine learning model based on the modified dataset;
determining whether an accuracy difference between the initial accuracy metric and the modified accuracy metric meets an accuracy threshold; and
based on the accuracy difference meeting the accuracy threshold, replacing the machine learning model with the new machine learning model.

12. The method of claim 11, further comprising:
determining an initial prediction speed for the machine learning model;
determining a modified prediction speed for the new machine learning model based on the modified dataset;
determining whether a prediction speed difference between the initial prediction speed and the modified prediction speed meets a prediction speed threshold; and
based on the accuracy difference meeting the accuracy threshold and the prediction speed difference meeting the prediction speed threshold, replacing the machine learning model with the new machine learning model.

13. The method of claim 2, wherein updating the machine learning model comprises:
selecting one or more hyperparameters associated with the machine learning model; and
adjusting the one or more hyperparameters based on the global sparsity metric.

14. The method of claim 2, wherein updating the machine learning model comprises:
selecting, based on the global sparsity metric, one or more features of the plurality of features; and
training a new machine learning model based on the one or more features.

15. One or more non-transitory, computer-readable media storing instructions that, when executed by one or more processors, cause operations comprising:
inputting, into a machine learning model, a dataset comprising a plurality of entries with each entry comprising a plurality of features to obtain a plurality of predictions, wherein the machine learning model is trained to generate predictions for entries based on features;
generating, for each entry of the plurality of entries, a plurality of feature impact parameters indicating a relative impact of each feature of the plurality of features on each prediction of the plurality of predictions;
determining a feature impact threshold for assessing which features of the plurality of features have contributed to each prediction;
generating, using the plurality of feature impact parameters and the feature impact threshold, a sparsity metric for each prediction, wherein the sparsity metric indicates which features of the plurality of features have relative impacts that meet the feature impact threshold for the prediction;
generating a global sparsity metric for the machine learning model; and
updating the machine learning model based on the global sparsity metric.

16. The one or more non-transitory, computer-readable media of claim 15, wherein determining the feature impact threshold comprises:
modifying the dataset to include an additional feature for each entry of the plurality of entries, wherein values for the additional features are randomly generated;
generating, for each entry of the additional plurality of entries, a corresponding additional feature impact parameter indicating a relative impact of a corresponding additional feature on each prediction of the plurality of predictions; and
determining the feature impact threshold based on a highest additional feature impact parameter.

17. The one or more non-transitory, computer-readable media of claim 15, wherein generating the sparsity metric for each prediction comprises:
determining whether a feature impact parameter for each feature associated with the prediction meets the feature impact threshold;
based on a first subset of the plurality of feature impact parameters for a first subset of features associated with the prediction meeting the feature impact threshold, determining that the first subset of features contributes to the prediction;
based on a second subset of the plurality of feature impact parameters for a second subset of features associated with the prediction not meeting the feature impact threshold, determining that the second subset of features does not contribute to the prediction; and
generating the sparsity metric for the prediction to include the first subset of features and exclude the second subset of features.

18. The one or more non-transitory, computer-readable media of claim 15, wherein updating the machine learning model comprises:
selecting, based on the global sparsity metric, one or more features of the plurality of features; and
training a new machine learning model based on the one or more features.

19. The one or more non-transitory, computer-readable media of claim 15, wherein the instructions further cause the one or more processors to perform operations comprising:
determining an initial accuracy metric for the machine learning model;
training a new machine learning model using a modified dataset comprising entries for a subset of the plurality of features to obtain new predictions;
determining a modified accuracy metric for the new machine learning model based on the modified dataset;
determining whether an accuracy difference between the initial accuracy metric and the modified accuracy metric meets an accuracy threshold; and
based on the accuracy difference meeting the accuracy threshold, replacing the machine learning model with the new machine learning model.

20. The one or more non-transitory, computer-readable media of claim 19, wherein the instructions further cause the one or more processors to perform operations comprising:
determining an initial prediction speed for the machine learning model;
determining a modified prediction speed for the new machine learning model based on the modified dataset;
determining whether a prediction speed difference between the initial prediction speed and the modified prediction speed meets a prediction speed threshold; and
based on the accuracy difference meeting the accuracy threshold and the prediction speed difference meeting the prediction speed threshold, replacing the machine learning model with the new machine learning model.
